(19) United States
(12) Patent Application Publication
(10) Pub. No.: US 2008/0127541 A1
(43) Pub. Date: Jun. 5, 2008

(54) FISHING LURE WITH KEEPER BARB

(75) Inventor: Michael T. Shelton, North Charleston, SC (US)

Correspondence Address: HAMMER & HANF, PC, 3125 SPRINGBANK LANE, SUITE G, CHARLOTTE, NC, 28226, US

(73) Assignee: Z-Man Fishing Products, Inc.

(21) Appl. No.: 11/950,676

(22) Filed: Dec. 5, 2007

Related U.S. Application Data
(60) Provisional application No. 60/868,600, filed on Dec. 5, 2006.

(51) Int. Cl. A01K 85/00; A01K 85/10

(52) U.S. Cl. 43/42.13; 43/42.08

(57) ABSTRACT

A fishing lure which is comprised of a jig head with a hook being attached to the jig head, and an eyelet being attached to the jig head. A shank is attached to the jig head which is substantially parallel to the hook. The shank has a proximal end and a distal end. An arcuate barb is located on the shank between the proximal end and the distal end.

### RELATED CASES

This application claims the Priority of the Provisional Application Ser. No. 60/868,600 filed Dec. 5, 2006.

### FIELD OF THE INVENTION

The instant invention relates to fishing lures and more specifically to a jig adapted to accept a plastic boded lure.

### BACKGROUND

A fishing lure is a bait; especially an artificial one, used in fishing. Some of these lures are a combination of a hook with a barb member adapted to accept a live bait, such as a fish, as can be seen in U.S. Pat. No. 2,836,922, U.S. Pat. No. 3,905,149 and U.S. Pat. No. 6,038,806. Other lures are a hook with an attachment for a bait holder, as can be seen in U.S. Pat. No. 4,334,381, U.S. Pat. No. 5,237,772, U.S. Pat. No. 5,890,317 and U.S. Pat. No. 6,405,477. When using live bait or a plastic body with a hook these lures tend to float but a sinker can be added to weigh the lure down in order to fish under water or near the bottom.

One versatile type of fishing lure is a jig. The jig usually consists of a weighted head with a hook molded into the weighted head. Often there is some sort of body attached to the shank of the hook.

The jig head may be configured in many different shapes and colors along with different features. One prevalent configuration for the jig is a round head, yet other configurations, including cone shaped heads may be used. These heads come in a variety of weights generally ranging 1/64 ounce (0.44 grams) to an ounce (28.35 grams) or more. The heads come in a myriad of patterns and colors. Hook type, angle, material and color might all vary. A weed guard may be offered with some jig heads.

Many different types of bodies are available for the jig. Most of these bodies are made of rubber, silicon or plastisol. Plastisol is combination of polyvinyl chloride (PVC) mixed with a plasticizer. Bodies are often molded in the shape of the animals which the fish, which one desires to catch, usually will pray upon. Examples of these body shapes include lizards, bugs, worms, grubs, frogs, fish, eels, mud dogs, salamanders, crayfish, shrimp and the like. Colors run the full gambit of the spectrum and may be blight, translucent, dark, florescent or glow in the dark. The bodies may include shiny flakes or translucent colors may be combined with contrasting flake colors. The body may also be a combination of feathers, scales, fur, rubber skirts and other materials.

Some examples of jig type lures can be seen in U.S. Pat. No. 4,777,758, U.S. Pat. No. 5,220,743, U.S. Pat. No. 5,551,185, U.S. Pat. No. 6,240,672 (see FIGS. 2, 5 and 6) and U.S. Pat. No. 7,140,146. Another example of the jig can be seen in US Publication No. 2005/0210731, which is incorporated herein by reference.

### SUMMARY OF THE INVENTION

A fishing lure that is comprised of a jig head, with a hook being attached to the jig head, and an eyelet being attached to the jig head. A shank is attached to the jig head which is substantially parallel to the hook. The shank has a proximal end and a distal end. An arcuate barb is located on the shank between the proximal end and the distal end.

### BRIEF DESCRIPTION OF THE DRAWINGS

The foregoing will become more readily apparent by referring to the following detailed description and the appended drawings in which:

FIG. 1 is a side view of an embodiment of the invention showing a jig head, hook and shank; and

FIG. 2 is a perspective view of another embodiment of the invention showing a jig head, hook and shank;

FIG. 3 is a perspective view of another embodiment of the invention showing a jig head, hook and elastomeric body;

FIG. 4 is a side view of another embodiment of the invention showing a jig head, blade, hook and shank; and

FIG. 5 is a perspective view of another embodiment of the invention showing a jig head, blade, hook and shank;

FIG. 6 is a perspective view of another embodiment of the invention showing a jig head, blade, hook and elastomeric body;

FIG. 7 is a head on view of the jig head with blade, showing the oscillation of the blade;

FIG. 8 is a side view of the shank;

FIG. 9 is a point on view of the shank;

FIG. 10 is another point on view of the shank;

FIG. 11 is another point on view of the shank;

FIG. 12 is a side view of another embodiment of the shank;

FIG. 13 is a cross section of an end on view of the jig;

FIG. 14 is a detailed view of a section of said shank; and

FIG. 15 shows a cross section of the shank and the arcuate barb.

### DETAILED DESCRIPTION OF THE INVENTION

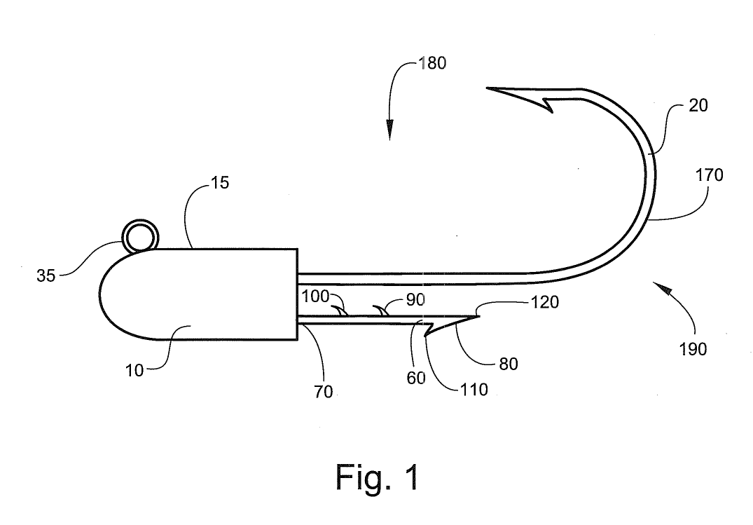

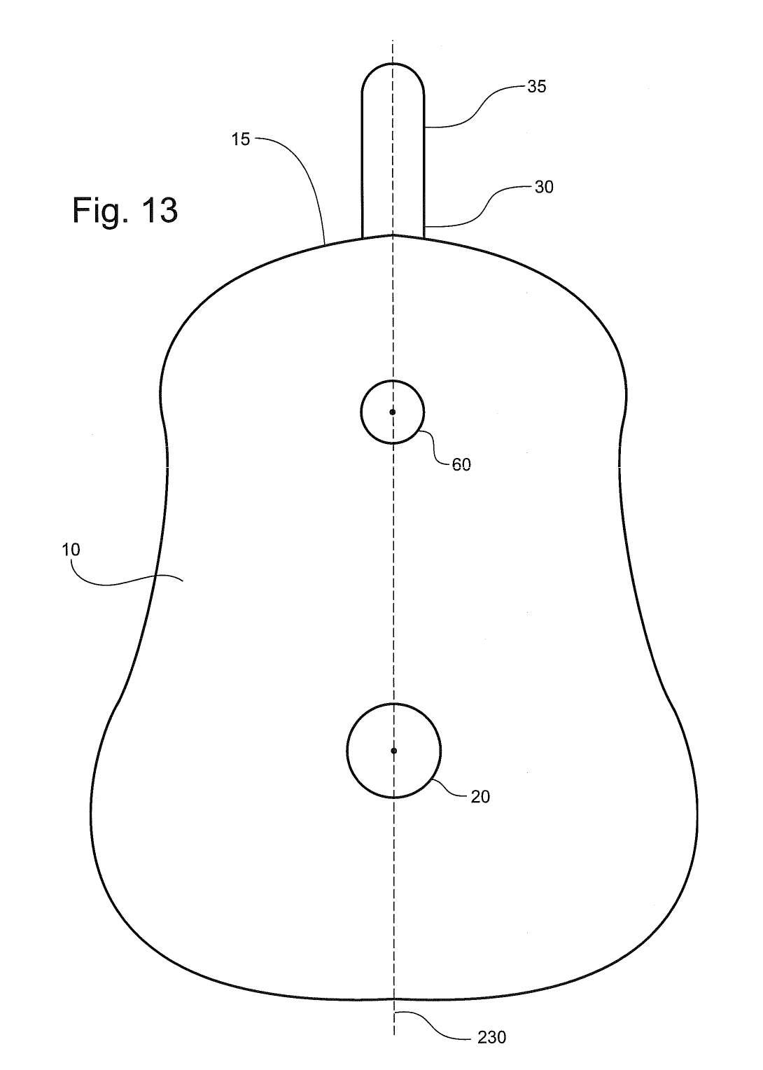

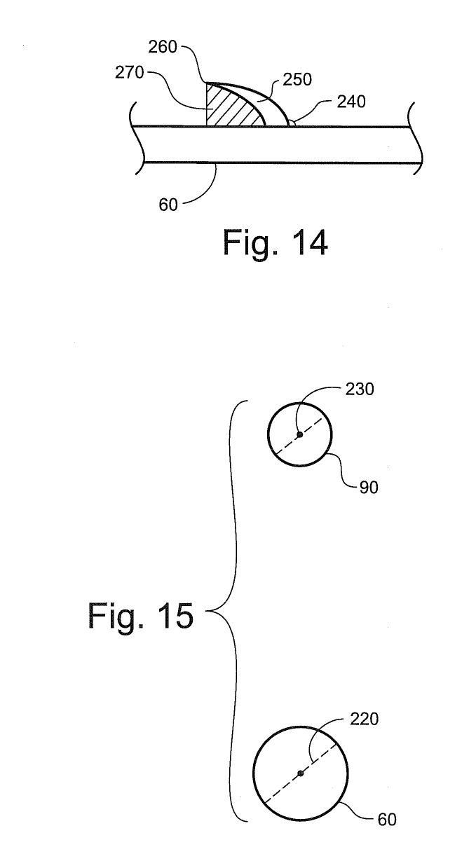

A fishing lure FIG. 1, which is comprised of a jig head 10 with a hook 20 being attached to the jig head 10, and an eyelet 35 being attached to the jig head 10. A shank 60 is attached to the jig head 10, which is substantially parallel to the hook 20. The shank 60 has a proximal end 70 and a distal end 80. At the distal end 80 of the shank 60 there is a point 120 and a barb 110. An arcuate barb 90 is located on the shank between the proximal end 70 and the distal end 80. The arcuate barb 90 has a proximal end 240, FIG. 14, and distal end 260, the distal end 260 having a point. The eyelet 35, the hook 20 and the shank 60 are aligned in a single plane 230, FIG. 13.

The jig head 10 in one embodiment is a weighted body, which allows this lure to be fished below the surface of the water. There are several ways to achieve this, either the head can be made of a plastic material which is filled with a material such as sand or a granulated metal such as tungsten, brass, steel, tin or lead which sinks when placed in water, or the jig head is comprised of a molded metal. As these lure are to be used in water it is desirable to use a metal which is not easily corroded. Examples of non-corrosive metals include: stainless steel, brass, tungsten, tin and lead. Stainless steal is an alloy of ferrous Fe metal with chromium Cr. There are in excess of 100 grades of stainless steal with about a dozen being the most common. As stainless steel is recyclable, it is a fairly ecofriendly material; over 50% of new stainless steel is rendered from scrap metal. Brass is an alloy of zinc and copper. By varying the amounts of zinc added can produce many different types of brasses with a wide array of qualities. Brass is malleable and resistant to tarnish. With good flow characteristics and a relatively low melting point, brass is a relatively easy metal to cast. A very hard steel-gray to white transitional metal, tungsten, has a higher melting point than any other non-alloy metal. Tin is a malleable, ductile metal which is resistant to corrosion but may be attacked by acids and bases. Lead has, for a long while, been a metal selected for sinkers as it is heavy, has a low melting point, and is easy to mold. This jig head 10 may be configured in wide variety of different shapes and colors. The jig head also comes in a variety of weights generally ranging 1/64 ounce (0.44 grams) to an ounce (28.35 grams) or more. The weight of the head will depend on the type of artificial body one intents to use with it as well as what type of water one is fishing in and how deep or shallow the lure is desired to go, which gives the fisherman more options in their tackle boxes.

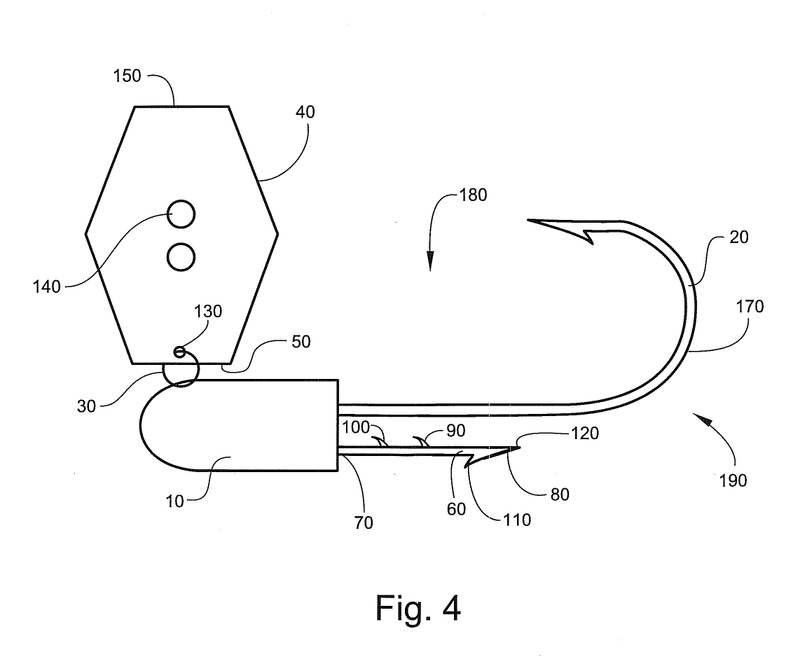

In another embodiment of the invention the fishing lure FIG. 4, which is comprised of a jig head 10 with a hook 20 being attached to the jig head 10, and an eyelet 30 being attached to the jig head 10. A blade 40 is attached to the eyelet 30 where the blade 40 has a proximal edge 50. In operation the blade 40 oscillating about the jig head 10 and strikes the proximal edge of the blade 50 upon the jig head 10 during the oscillation in one direction. A shank 60 is attached to the jig head 10, which is substantially parallel to the hook 20. The shank has a proximal end 70 and a distal end 80. An arcuate barb 90 is located on the shank between the proximal end 70 and the distal end 80.

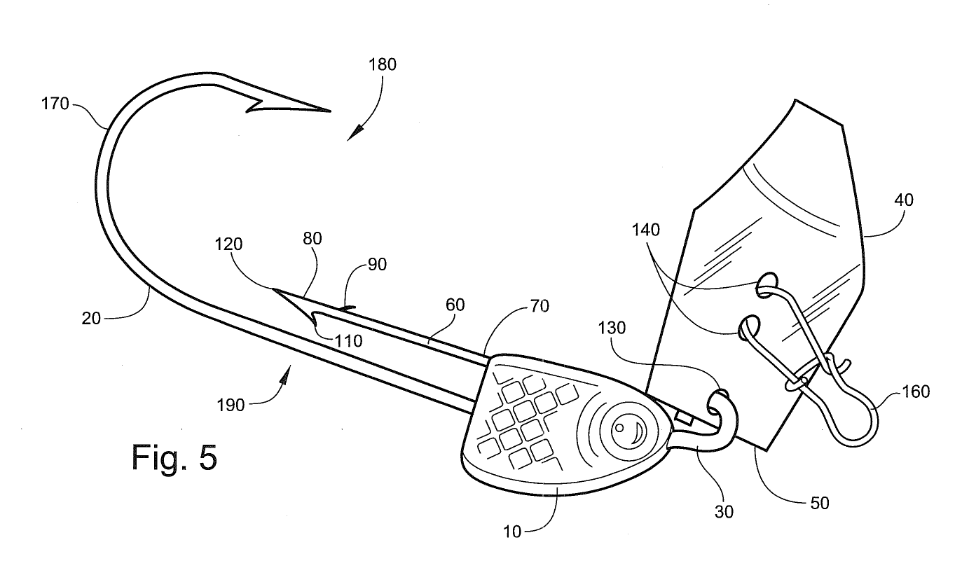

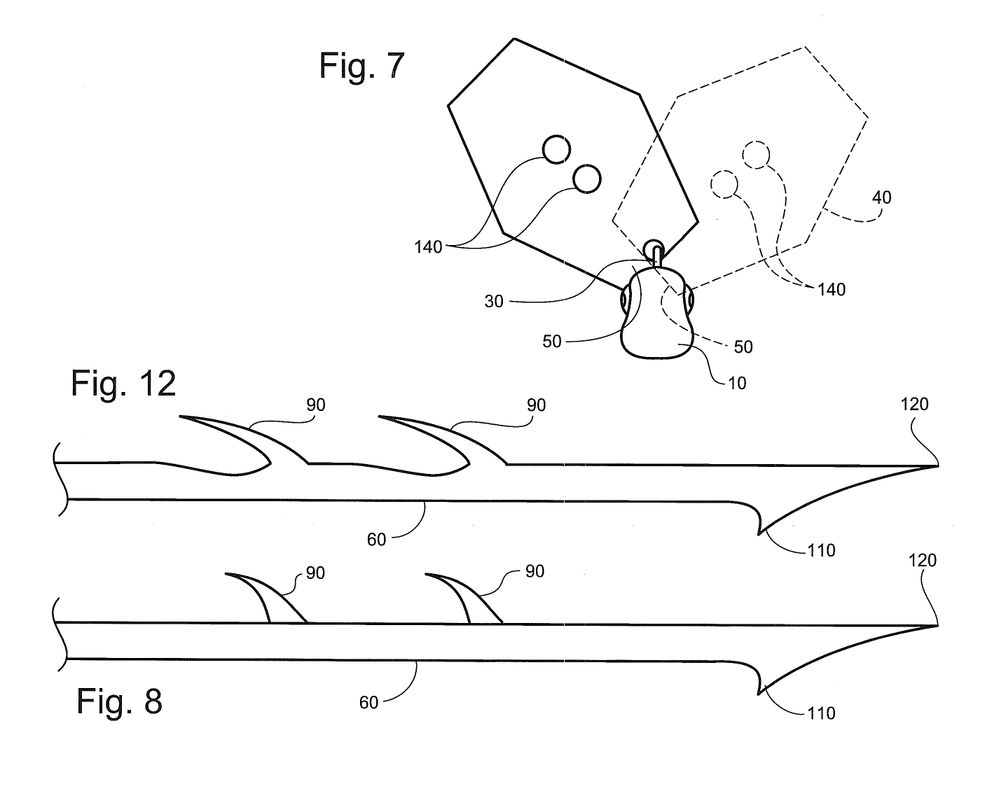

The jig head 10, FIG. 5, has an eyelet 30 attached to journal a blade 40 which has a proximal edge 50. The eyelet is mounted on one side of the jig head 10. A centrally positioned aperture 130 is located close to the proximal edge 50 of the blade 40. The blade also has a pair of centrally positioned apertures 140 for line attachment, which are spaced from centrally positioned aperture 130. In one embodiment these apertures are spaced in close proximity to the central aperture 130, in another embodiment the pair of apertures 140 are spaced close to the distal edge 150 of the blade, in yet another embodiment they a position central to the proximal edge 50 and the distal edge 150 of the blade 40 as shown in FIG. 4. The pair of centrally positioned apertures 140 is used for line attachment which is adapted to receive a snap fastener 160 as shown in FIG. 5. The blade 40 is limited to side to side motion through contact with either the jig head 10 or the eyelet 30 as shown in FIG. 7. During this side to side action the blade 40, FIG. 7, oscillates about the jig head 10 and strikes the proximal edge of the blade 50 upon the jig head 10 during the oscillation in one direction. This striking creates a noise which is thought to be attractive to fish. The blade is made of a metal material which is chosen from the group of aluminum, brass, stainless steel, tin or tungsten. The blade may be colored. However, it has been found that a shiny metal blade works well.

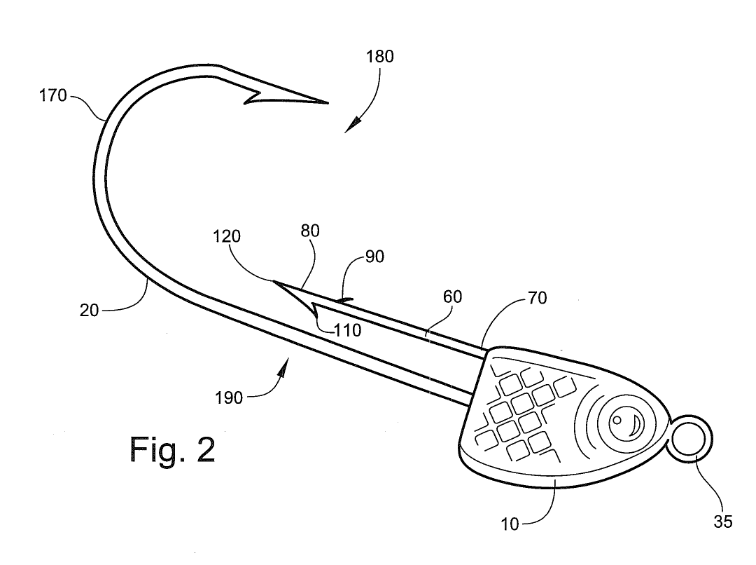

The lure is comprised of a jig head 10, FIG. 5, with a hook 20 being attached to the jig head 10, and an eyelet 30 being attached to the jig head 10. A blade 40 is attached to the eyelet 30 where the blade 40 has a proximal edge 50. A shank 60 is attached to the jig head 10, which is substantially parallel to the hook 20. The eyelet 30 in one embodiment is connected to the upper portion 15, FIG. 1, of the jig head 10. The eyelet 30 is comprised of a metal loop. If one considers the hook end 170 of the hook 20 to define a plane the eyelet 30 will be co-planar with the hook end, see FIG. 13. The shank 60 will also be coplanar with the eyelet 30 and the hook end 170. In one embodiment of the invention the hook 20 has an open side 180 and a closed side 190 and the shank 60 being attached to the jig head 10 on the closed side 190 of the hook as seen in FIG. 1. In another embodiment of the invention the hook 20 has an open side 180 and a closed side 190 and the shank 60 being attached to the jig head 10 on the open side 180 of the hook as seen in FIG. 2.

The upper portion 15, FIG. 1 of the jig head 10, is defined so that, looking at the jig head 10 in FIG. 2, the hook 20, in one embodiment, essentially bisects the jig head, then anything attached on the open side of the hook 180 such as the shank 60 and the eyelet 35 are attached to the upper portion 15 of the hook and any part of the head below the hook 20 on the closed side 190 would be a lower portion. Now in embodiments where the hook does not essentially bisect the jig head 10, FIG. 1, then one needs to simply image a line bisecting the head and anything above that line, such as the eyelet 35 and the hook 20 are attached to the upper portion 15, anything below that line is attached to a lower portion, such as the shank 60, FIG. 1.

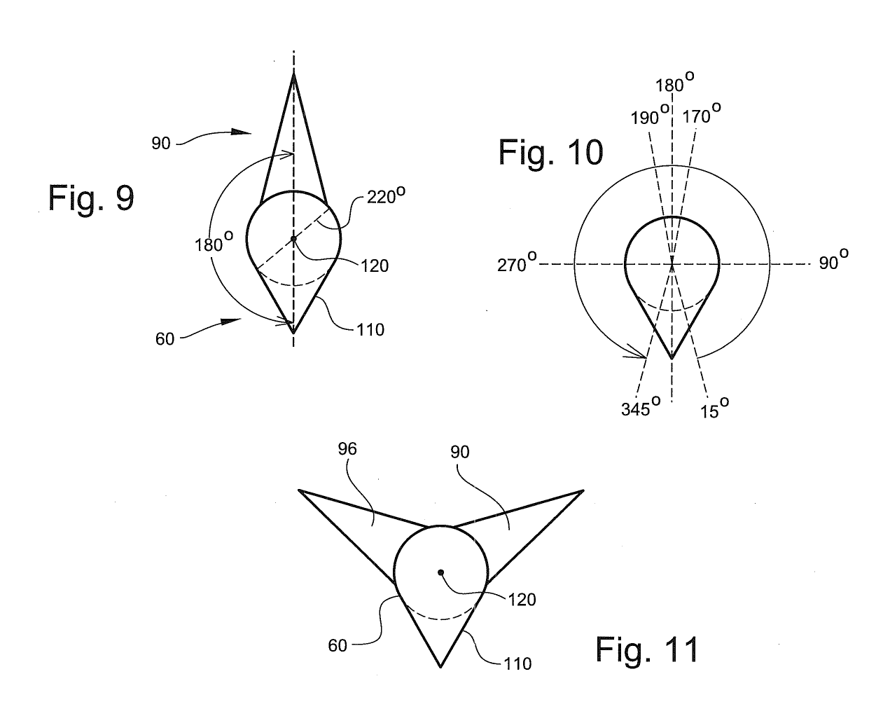

The shank 60, FIG. 2, has a proximal end 70 and a distal end 80. In one embodiment of the invention the shank 60 has a point 120 at the distal end 80 with a barb 110. An arcuate barb 90 is located on the shank between the proximal end 70 and the distal end 80. In one embodiment the arcuate barb 90 has a shaft, which is less than one half the diameter of the shank 60. In another embodiment the arcuate barb 90 has a shaft 250, FIG. 14 which at its thickest 240 is less than one quarter the diameter of the shank 60, FIG. 15. The arcuate barb 90 is made up of a shaft 250 which is thickest at its proximal end 240 and has a point at its distal end 260. The point 260 and shaft 250, FIG. 11, define an area 270 between the arcuate barb 90 and the shank 60, which, in one embodiment, is greater that the area of the arcuate barb 90. In one embodiment the arcuate barb 90, FIG. 9, is located 180° from the barb 110 on the pointed end 120 of the shank 60. Another embodiment of the invention has the arcuate barb 90, FIG. 10, located from 15° to 345° from the barb 110 on the pointed end 120 of the shank 60. An arcuate barb 90, which is not located within the same plane as the plane defined by the barb 110 and the pointed end 120 of the shank is shown in FIG. 11, is another embodiment. In another embodiment, the arcuate barb 90 is located from 15° to 170° and from 190° to 345° from the barb 110 on the pointed end 120 of shank 60, FIG. 10.

In one of the embodiments of the invention there is a plurality of arcuate barbs 90, 100, FIG. 1. The arcuate barbs 90, 100, FIG. 1, are located on the shank 60 between the proximal end 70 and the distal end 80. In one embodiment the arcuate barbs 90 have a shaft, which is less than one half the diameter of the shank 60. In another embodiment the arcuate barbs 90 have a shaft 250, FIG. 14 which at its thickest 240 is less than one quarter the diameter of the shank 60, FIG. 15. In one embodiment the arcuate barbs 90, 100, FIG. 1, are located 180°, FIG. 9, from the barb 110 on the pointed end 120 of the shank 60. Another embodiment of the invention has, the arcuate barbs 90, are located from 15° to 345°, FIG. 10, from the barb 110 on the pointed end 120 of the shank 60. The arcuate barbs 90, 96, which are not located within the same plane as the plane defined by the barb 110 and the pointed end 120 of the shank is shown in FIG. 11, in another embodiment. In another embodiment the arcuate barbs 90 are located from 15° to 170° and from 190° to 345° from the barb 110 on the pointed end 120 of shank 60, FIG. 10.

Arcuate, as used in this application, means to bend like a bow, bent, crooked or curved, where bow means to bend or incline. Examples of an arcuate bard 90 or these arcuate barbs 90 can be seen in FIGS. 8 and 12. The arcuate barb has a proximal end 240 a shaft 250 and a distal end 260 the distal end 260 is pointed. There exists a space under the arcuate barb 90, which is shown in FIG. 14 as 270, which exists under the shaft 250 and the distal end 260.

In another embodiment of the invention, the fishing lure, FIG. 4, which is comprised of a jig head 10 with a hook 20 being attached to the jig head 10, and an eyelet 30 being attached to the jig head 10. The jig head 10 is weighted. The hook 20 has an open side 180 and a closed side 190. Jig head 10 has an upper end 15, FIG. 1, and the eyelet 30 is attached to the upper end 15, FIG. 10. A blade 40 is attached to the eyelet 30 where the blade 40 has a proximal edge 50. In operation the blade 40 oscillating about the jig head 10 and strikes the proximal edge of the blade 50 upon the jig head 10 during the oscillation in one direction, FIG. 7. A cylindrical shank 60 is attached to the jig head 10, which is substantially parallel to the hook 20. The shank 60 has a proximal end 70 and a distal end 80. The shank 60 also has a point 120 and a barb 110 at the distal end 80. An arcuate barb 90 is located on the shank between the proximal end 70 and the distal end 80 and being spaced at least 15° from the barb 110 on the cylindrical shank 60, FIG. 10. The eyelet 30 the hook 20 and the shank 60 are aligned in a single plane 230, FIG. 13. The eyelet 30, 35 is attached to the jig head 10 at the upper end 15, FIG. 13. The open side 180 of the hook 20 is open on the upper side 15 of the jig head 10 as shown in FIG. 2.

In one embodiment of the invention the shank 60 is attached to the jig head 10 on the open side 180 of the hook 20, FIG. 5. In another embodiment of the invention the shank 60 is attached to the jig head 10 on the closed side 190 of the hook 20, FIG. 4. In another embodiment of the invention the jig head 10 is metal. The metal of the jig head 10 is selected from the group consisting of: stainless steel, brass, tungsten, tin and lead.

In another embodiment of the invention, the fishing lure, FIG. 5, which consists essentially of a jig head 10 with a hook 20 being attached to the jig head 10, and an eyelet 30 being attached to the jig head 10. The jig head 10 is weighted. This jig head 10 is metal, with the metal of the jig head 10 selected from the group consisting of: stainless steel, brass, tungsten, tin and lead. The hook 20 has an open side 180 and a closed side 190. Jig head 10 has an upper end 15, FIG. 1 and the eyelet 30, FIG. 5, is attached to the upper end 15, FIG. 13. A blade 40, FIG. 4, is attached to the eyelet 30 where the blade 40 has a proximal edge 50. In operation the blade 40 oscillating about the jig head 10 and strikes the proximal edge of the blade 50 upon the jig head 10 during the oscillation in one direction, FIG. 7. A cylindrical shank 60, FIG. 5, is attached to the jig head 10, which is substantially parallel to the hook 20. The shank has a proximal end 70 and a distal end 80. The shank 60 also has a point 120 and a barb 110 at the distal end 80. An arcuate barb 90 is located on the shank between the proximal end 70 and the distal end 80 and being spaced at least 15° from the barb 110 on the cylindrical shank 60, FIG. 10. The eyelet 30 the hook 20 and the shank 60 are aligned in a single plane 230, FIG. 13. The eyelet 30, 35 is attached to the jig head 10 at the upper end 15, FIG. 13. The open side 180 of the hook 20 is open on the upper side of the jig head 10 as shown in FIG. 5.

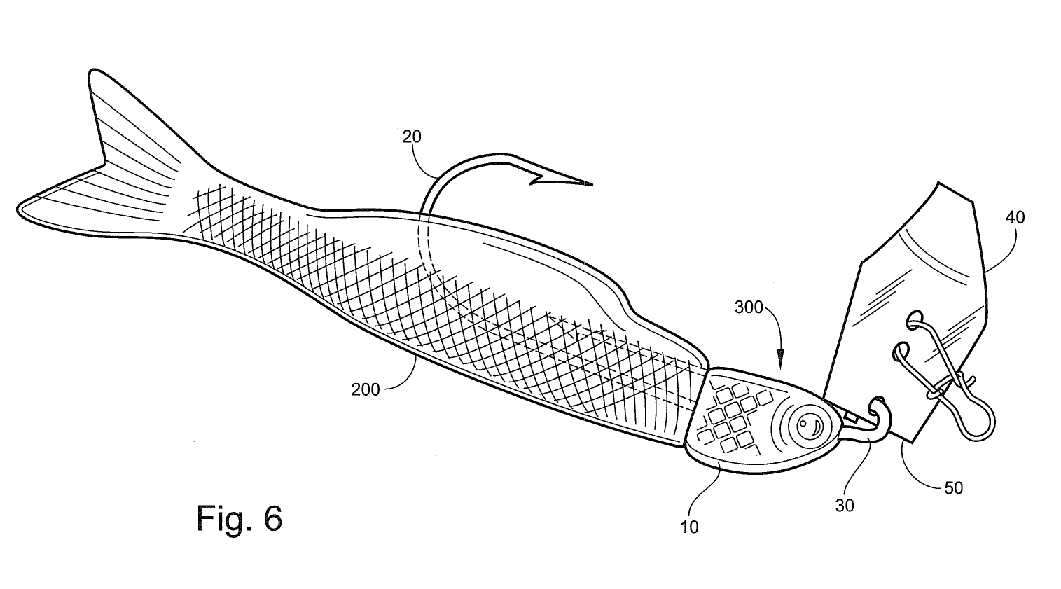

In one embodiment of the invention the shank 60 is attached to the jig head 10 on the open side 180 of the hook 20, FIG. 5. In another embodiment of the invention the shank 60 is attached to the jig head 10 on the closed side 190 of the hook 20, FIG. 4. In another embodiment of the invention the jig head 10 is configured to look like a head of a fish, see FIG. 6.

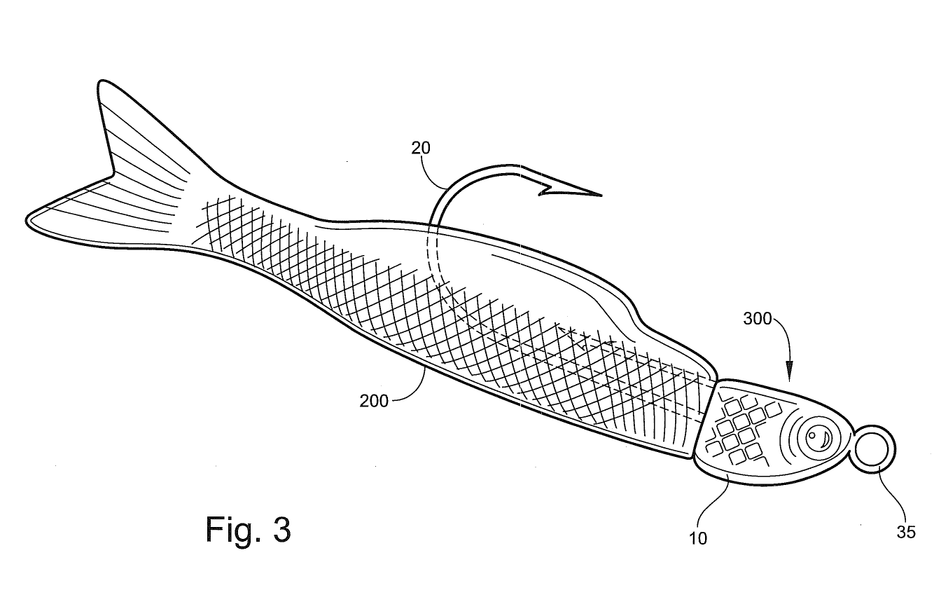

In one embodiment of the invention, the shank 60 is adapted to receive a styrenic blocked co-polymer body 200 having a shore OO durometer of 3 to 20. Many of the artificial bodies in the past have been made of rubber or plastisol. Plastisol is a copolymer of PVC with an elastomer but it tends to produce a body which is harder than that of a live fish. The elastomeric fishing body 200, FIG. 3, FIG. 6, of the invention has a Shore 00 hardness of 3-20. The body is comprised of an oil, where the oil is 79-90% by weight of the body and a styrenic block copolymer which is 10 to 21% by weight of the body. This styrenic block copolymer is selected from the group of: SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene) and combinations thereof. The body may also have an additive selected from the group of: anti-oxidants, heat stabilizers, oxidation inhibitors; in an amount from 0 to 5% by weight. More information of these types of composition can been found in the co-pending application WO 2006/099279.

The Shore hardness is measured with an apparatus known as a Durometer and consequently is also known as ‘Durometer hardness’. The hardness value is determined by the penetration of the Durometer indenter foot into the sample. Because of the resilience of rubbers and plastics, the indentation reading may change over time—so the indentation time is sometimes reported along with the hardness number. The ASTM test method designation is ASTM D2240 OO and is generally used in North America. Related methods include ISO 7619 and ISO 868; DIN 53505; and JIS K 6301, which was discontinued and superseded by JIS K 6253. The results obtained from this test are a useful measure of relative resistance to indentation of various grades of polymers. The lures having a OO durometer in the range of 10-20 have been found to be highly effective for both fresh and salt water fishing.

A styrenic block copolymer body, especially one have having a Shore Durometer OO hardness in the range of 3-20, feels more lifelike than a harder plastisol body an does not rip or tear as the plastisol body has the tendency to.

We claim:

1. A fishing lure comprising:
a jig head;
a hook being attached to said jig head;
an eyelet being attached to said jig head;
a shank being attached to said jig head and being substantially parallel to said hook, said shank having a proximal end and a distal end, said distal end having a point and a barb;
an arcuate barb located on said shank between said proximal end and said distal end, where said arcuate barb has a proximal end and a distal end, said distal end of said arcuate barb has a point; and
where said eyelet, said hook and said shank are aligned in a single plane.

2. The fishing lure of claim 2 where there are a plurality of arcuate barbs.

3. The fishing lure of claim 1 where said hook has an open side and a closed side and said shank being attached to said jig head on said closed side of said hook.

4. The fishing lure of claim 1 where said hook has an open side and a closed side and said shank being attached to said jig head on said open side of said hook.

5. The fishing lure of claim 2 where said hook has an open side and a closed side and said shank being attached to said jig head on said closed side of said hook.

6. The fishing lure of claim 2 where said shank being attached to said jig head on the open side of said hook.

7. The fishing lure of claim 1 where said arcuate barb is located 180° from said barb on said pointed end.

8. The fishing lure of claim 1 where said arcuate barb is located from 15° to 345° from said barb on said pointed end.

9. The fishing lure of claim 1 where said pointed end and said barb create a plane and said arcuate barb is not located within the same plane.

10. The fishing lure of claim 2 where said pointed end and said barb create a plane and where the plurality of arcuate barbs are not located within the same plane as said pointed end and said barb.

11. The fishing lure of claim 11 where said plurality of arcuate barbs are located from 15° to 170° and from 195° to 350° from said barb on said pointed end.

12. The fishing lure of claim 1 where said arcuate barb has a shaft which is less than one half the diameter of said shank.

13. The fishing lure of claim 1, further comprising a blade being attached to said eyelet wherein said blade has a proximal edge, said blade oscillating about said jig head and striking said edge upon said jig head during the oscillation in one direction.

14. A fishing lure comprising:
a jig head where said jig head is weighted and has an upper end;
a hook being attached to said jig head where said hook has an open side and a closed side;
an eyelet being attached to said jig;
a cylindrical shank being attached to said jig head and being substantially parallel to said hook, said shank having a proximal end and a distal end where said shank has a point and a barb located at said distal end;
an arcuate barb located on said shank between said proximal end and said distal end and being spaced at least 15° from said barb on said cylindrical shaft, where said arcuate barb has a proximal end and a distal end, said distal end of said arcuate barb having a point, said arcuate barb has a shaft which is less than one half the diameter of said cylindrical shank;
where said eyelet, said hook and said shank are aligned in a single plane; and
where said eyelet is attached to said upper end of said jig head and said open side of said hook is open on the upper end of said jig head.

15. The fishing lure of claim 14 further comprising a blade being attached to said eyelet wherein said blade having a proximal edge, said blade oscillating about said jig head and striking said edge upon said jig head during the oscillation in one direction, said blade being metal.

16. The fishing lure of claim 14 where said jig head is metal.

17. The fishing lure of claim 16 where said metal is selected from the group consisting of: lead, tungsten, brass, stainless steel and tin.

18. A fishing lure consisting essentially of:
a jig head where said jig head is weighted and made of metal selected from the group consisting of: lead, tungsten, brass, stainless steel and tin;
a hook being attached to said jig head;
an eyelet being attached to said jig head;
a blade being attached to said eyelet where said blade has a proximal edge, said blade oscillating about said jig head and striking said edge upon said jig head during the oscillation in one direction, said blade being metal;
a cylindrical shank being attached to said jig head and being substantially parallel to said hook, said shank having a proximal end and a distal end where said shank has a point and a barb located at said distal end, said shank being attached to said jig head on an open side of said hook;
an arcuate barb, or a plurality of arcuate bards, located on said shank between said proximal end and said distal end and being spaced at least 15° from said barb where said arcuate barb, or said arcuate barbs, have a shaft which is less than one half the diameter of said cylindrical shank;
where said eyelet, said hook and said shank are aligned in a single plane; and
where said eyelet is attached to said upper end of said jig head and said open side of said hook is open on the upper end of said jig head.

19. The fishing lure of claim 18 where said jig head is configured to look like a head of a fish.

20. The fishing lure of claim 18 where said shank is adapted to receive a styrenic blocked co-polymer body having a shore OO durometer of 3 to 20.
